(19) United States
(12) Patent Application Publication
(10) Pub. No.: US 2016/0198472 A1
(43) Pub. Date: Jul. 7, 2016

(54) Transmit End, Receive End, and Method for Coexistence of Single Carrier System and Multicarrier System

(71) Applicant: Huawei Technologies Co., Ltd., Shenzhen (CN)

(72) Inventors: Yiling Wu, Beijing (CN); Guangwei Yu, Beijing (CN); Tong Ji, Beijing (CN); Weiliang Zhang, Beijing (CN)

(21) Appl. No.: 15/071,952

(22) Filed: Mar. 16, 2016

Related U.S. Application Data
(63) Continuation of application No. PCT/CN2014/086680, filed on Sep. 17, 2014.

(30) Foreign Application Priority Data
Sep. 17, 2013 (CN) 201310426076.6

(51) Int. Cl. H04W 72/04; H04L 27/26

(52) U.S. Cl. CPC H04W 72/0453; H04L 27/2637

(57) ABSTRACT

The signal transmitting method includes that a transmit end modulates a first frequency band that corresponds to a first signal to be transmitted by the single carrier system onto a second frequency band that corresponds to a second signal to be transmitted by the multicarrier system, to obtain a transmit signal including at least the first signal and/or the second signal. A spacing between a center frequency of a first subchannel and a center frequency of a second subchannel is an integer multiple of a spacing between two adjacent second subchannels. A signal bandwidth that corresponds to the first subchannel is less than or equal to a signal bandwidth that corresponds to the second subchannel. The method includes transmitting the transmit signal to a receive end for completing reception of the first signal and the second signal.

This application is a continuation of International Application No. PCT/CN2014/086680, filed on Sep. 17, 2014, which claims priority to Chinese Patent Application No. 201310426076.6, filed on Sep. 17, 2013, both of which are hereby incorporated by reference in their entireties.

### TECHNICAL FIELD

The present invention relates to the field of communications technologies, and in particular, to a transmit end, a receive end, and a method for coexistence of a single carrier system and a multicarrier system.

### BACKGROUND

At present, an increasing demand on communications services is straining spectrum resources worldwide. Because the spectrum resources are limited, to improve spectrum utilization and to efficiently use existing spectra has become an important means of operators to enhance competitiveness.

In the prior art, signal transmission by means of coexistence of a single carrier system and a multicarrier system has been widely used. A system using only one carrier frequency or one carrier for signal transmission is referred to as a single carrier system. A system using multiple carrier frequencies or multiple carriers for signal transmission is referred to as a multicarrier system. Because the single carrier system has a relatively narrow signal bandwidth and a relatively high spectrum density, in practical signal transmission, a multicarrier signal is merely equivalent to relatively low noise that is added to bandwidth allocated to a single carrier signal, and has extremely low interference on the single carrier system. However, compared with the multicarrier signal, the single carrier signal is a narrowband interference signal, and extremely easily causes spectrum spreading on a receive end of the multicarrier signal, thereby seriously interfering with transmission of the multicarrier signal, reducing performance of the multicarrier system, and affecting spectrum utilization.

### SUMMARY

It is an object of the disclosure to provide a concept which improves spectrum utilization.

A first aspect provides a signal transmitting method for coexistence of a single carrier system and a multicarrier system. The method includes modulating, by a transmit end, a first frequency band that corresponds to a first signal to be transmitted by the single carrier system onto a second frequency band that corresponds to a second signal to be transmitted by the multicarrier system, to obtain a transmit signal, where the transmit signal includes at least the first signal and/or the second signal, the first signal is carried by multiple first subchannels, the second signal is carried by multiple second subchannels, a spacing between a center frequency of the first subchannel and a center frequency of the second subchannel is an integer multiple of a spacing between two adjacent second subchannels, and a signal bandwidth that corresponds to the first subchannel is less than or equal to a signal bandwidth that corresponds to the second subchannel. The method also includes transmitting the transmit signal to a receive end for completing reception of the first signal and the second signal.

With reference to an implementation manner of the first aspect, or a first possible implementation manner of the first aspect, the method includes: setting a guard interval between the first frequency band and the second frequency band.

With reference to the implementation manner of the first aspect, in a second possible implementation manner of the first aspect, if the transmit end is a base station and the receive end is a mobile phone, the modulating, by a transmit end, a first frequency band that corresponds to a first signal to be transmitted by the single carrier system onto a second frequency band that corresponds to a second signal to be transmitted by the multicarrier system, to obtain a transmit signal includes: sequentially performing, by the transmit end, channel coding, constellation diagram mapping, multi-rate filtering, and up-conversion on communication data to be transmitted, to acquire the first frequency band that corresponds to the first signal to be transmitted by the single carrier system, modulating the first frequency band onto the second frequency band that corresponds to the second signal to be transmitted by the multicarrier system, to obtain a coexistence frequency band; and performing digital-to-analog conversion on a digital signal that corresponds to the coexistence frequency band, to obtain the transmit signal.

With reference to the implementation manner of the first aspect, in a third possible implementation manner of the first aspect, if the transmit end is a mobile phone and the receive end is a base station, the modulating, by a transmit end, a first frequency band that corresponds to a first signal to be transmitted by the single carrier system onto a second frequency band that corresponds to a second signal to be transmitted by the multicarrier system, to obtain a transmit signal includes: separately performing, by the transmit end, channel coding, constellation diagram mapping, and digital-to-analog conversion sequentially on communication data to be sent by the single carrier system and communication data to be sent by the multicarrier system, performing up-conversion on the first signal to be transmitted by the single carrier system and the second signal to be transmitted by the multicarrier system, where digital-to-analog conversion has been performed on the first signal and the second signal, to acquire the first frequency band that corresponds to the first signal, and modulating the first frequency band onto the second frequency band that corresponds to the second signal, to obtain a coexistence frequency band and the transmit signal that corresponds to the coexistence frequency band.

With reference to the implementation manner of the first aspect, in a fourth possible implementation manner of the first aspect, the single carrier system is a Global System for Mobile Communications (GSM) system, and the multicarrier system is an orthogonal frequency division multiplexing (OFDM) system.

A second aspect provides a transmit end. The transmit end includes a processor, configured to modulate a first frequency band that corresponds to a first signal to be transmitted by a single carrier system onto a second frequency band that corresponds to a second signal to be transmitted by a multicarrier system, to obtain a transmit signal, where the transmit signal includes at least the first signal and/or the second signal, the first signal is carried by multiple first subchannels, the second signal is carried by multiple second subchannels, a spacing between a center frequency of the first subchannel and a center frequency of the second subchannel is an integer multiple of a spacing between two adjacent second subchannels, and a signal bandwidth that corresponds to the first subchannel is less than or equal to a signal bandwidth that corresponds to the second subchannel. The transmit end also includes a transceiver, configured to receive the transmit signal obtained by the processor, and transmit the transmit signal to a receive end for completing reception of the first signal and the second signal.

With reference to an implementation manner of the second aspect, in a first possible implementation manner of the second aspect, the processor is configured to set a guard interval between the first frequency band and the second frequency band.

With reference to the implementation manner of the second aspect, in a second possible implementation manner of the second aspect, the processor is further configured to, if the transmit end is a base station and the receive end is a mobile phone, sequentially perform channel coding, constellation diagram mapping, multi-rate filtering, and up-conversion on communication data to be sent, to acquire the first frequency band that corresponds to the first signal to be transmitted by the single carrier system, modulate the first frequency band onto the second frequency band that corresponds to the second signal, to obtain a coexistence frequency band, and perform digital-to-analog conversion on a signal that corresponds to the coexistence frequency band, to obtain the transmit signal.

With reference to the implementation manner of the second aspect, in a third possible implementation manner of the second aspect, the processor is further configured to, if the transmit end is a mobile phone and the receive end is a base station, separately perform channel coding, constellation diagram mapping, and digital-to-analog conversion sequentially on communication data to be sent by the single carrier system and communication data to be sent by the multicarrier system, perform up-conversion on the first signal and the second signal on which digital-to-analog conversion has been performed, to acquire the first frequency band that corresponds to the first signal to be transmitted by the single carrier system, and modulate the first frequency band onto the second frequency band that corresponds to the second signal to be transmitted by the multicarrier system, to obtain a coexistence frequency band and the transmit signal that corresponds to the coexistence frequency band.

With reference to the implementation manner of the second aspect, in a fourth possible implementation manner, the single carrier system is a GSM system, and the multicarrier system is an OFDM system.

A third aspect provides a signal receiving method for coexistence of a single carrier system and a multicarrier system. The method includes receiving, by a receive end, a transmit signal transmitted by a transmit end, where the transmit signal includes at least a first signal and/or a second signal, a first frequency band that corresponds to the first signal transmitted by the single carrier system is modulated onto a second frequency band that corresponds to the second signal transmitted by the multicarrier system, the first signal is carried by multiple first subchannels, the second signal is carried by multiple second subchannels, a spacing between a center frequency of the first subchannel and a center frequency of the second subchannel is an integer multiple of a spacing between two adjacent second subchannels, and a signal bandwidth that corresponds to the first subchannel is less than or equal to a signal bandwidth that corresponds to the second subchannel; and completing, by the receive end, reception of the first signal transmitted by the single carrier system and the second signal transmitted by the multicarrier system.

With reference to an implementation manner of the third aspect, in a first possible implementation manner, after the receiving, by a receive end, a transmit signal transmitted by a transmit end, the method includes: performing analog-to-digital conversion on the transmit signal, to obtain a corresponding digital signal; performing down-conversion on the digital signal, to demodulate the first frequency band that corresponds to the first signal and the second frequency band that corresponds to the second signal, and to acquire the first signal transmitted by the single carrier system and the second signal transmitted by the multicarrier system; and separately performing constellation diagram parsing and channel decoding sequentially on the first signal and the second signal, to obtain corresponding communication data.

With reference to the implementation manner of the third aspect, in a second possible implementation manner, the single carrier system is a GSM system, the multicarrier system is an OFDM system, and the transmit end is a mobile phone and the receive end is a base station, or the transmit end is a base station and the receive end is a mobile phone.

A fourth aspect provides a receive end. The receive end includes a receiver, configured to receive a transmit signal transmitted by a transmit end, where the transmit signal includes at least a first signal and/or a second signal, a first frequency band that corresponds to the first signal transmitted by a single carrier system is modulated onto a second frequency band that corresponds to the second signal transmitted by a multicarrier system, the first signal is carried by multiple first subchannels, the second signal is carried by multiple second subchannels, a spacing between a center frequency of the first subchannel and a center frequency of the second subchannel is an integer multiple of a spacing between two adjacent second subchannels, and a signal bandwidth that corresponds to the first subchannel is less than or equal to a signal bandwidth that corresponds to the second subchannel. The receive end also includes a processor, configured to complete, according to the transmit signal received by the receiver, reception of the first signal transmitted by the single carrier system and the second signal transmitted by the multicarrier system.

With reference to an implementation manner of the fourth aspect, in a first possible implementation manner, the processor is further configured to perform analog-to-digital conversion on the transmit signal, to obtain a corresponding digital signal, and perform down-conversion on the digital signal, to demodulate the first frequency band that corresponds to the first signal and the second frequency band that corresponds to the second signal, to acquire the first signal transmitted by the single carrier system and the second signal transmitted by the multicarrier system. The processor is further configured to separately perform constellation diagram parsing and channel decoding sequentially on the first signal and the second signal, to obtain corresponding communication data.

With reference to the implementation manner of the fourth aspect, in a second possible implementation manner, the single carrier system is a GSM system, the multicarrier system is an OFDM system, and the transmit end is a mobile phone and the receive end is a base station, or the transmit end is a base station and the receive end is a mobile phone.

By using the foregoing solutions, the embodiments achieve the following beneficial effects: The embodiments design that a transmit end modulates a first frequency band that corresponds to a first signal to be transmitted by a single carrier system onto a second frequency band that corresponds to a second signal to be transmitted by a multicarrier system, to obtain a transmit signal including at least the first signal and/or the second signal, and transmits the transmit signal to a receive end, so that the receive end completes reception of the first signal and the second signal. The first signal is carried by multiple first subchannels, and the second signal is carried by multiple second subchannels. A spacing between a center frequency of the first subchannel and a center frequency of the second subchannel is an integer multiple of a spacing between two adjacent second subchannels, so that the first signal and the second signal have close frequencies during reception and low mutual interference; in addition, a signal bandwidth that corresponds to the first subchannel is less than or equal to a signal bandwidth that corresponds to the second subchannel, so that the first single transmitted by the single carrier system is merely relatively low noise compared with second signal transmitted by the multicarrier system, and has extremely low interference. Based on the above, the embodiments can reduce the mutual interference between the single carrier system and the multicarrier system during signal transmission, ensure that spectrum resources are shared between heterogeneous systems, and improve spectrum utilization.

### BRIEF DESCRIPTION OF THE DRAWINGS

To describe the technical solutions in the embodiments of the present invention more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts. In the accompanying drawings:

FIG. 1 is a flowchart of a signal transmitting method for coexistence of a single carrier system and a multicarrier system according to a first embodiment;

FIG. 2 is a diagram of a signal transmission architecture in which a single carrier system and a multicarrier system coexist according to the embodiment;

FIG. 3 is a schematic diagram of a coexistence frequency band when a single carrier system and a multicarrier system coexist according to a first embodiment;

FIG. 4 is schematic diagram of a coexistence frequency band when a single carrier system and a multicarrier system coexist according to a second embodiment;

FIG. 5 is a flowchart of a signal receiving method for coexistence of a single carrier system and a multicarrier system according to a first embodiment;

FIG. 6 is a flowchart of a signal transmission method for coexistence of a single carrier system and a multicarrier system according to an embodiment;

FIG. 7 is a functional block diagram of a transmit end and a receive end according to an embodiment; and

FIG. 8 is a schematic diagram of hardware of a transmit end and a receive end according to an embodiment.

### DETAILED DESCRIPTION OF ILLUSTRATIVE EMBODIMENTS

The following clearly and completely describes the technical solutions in the embodiments of the present invention with reference to the accompanying drawings in the embodiments of the present invention. Apparently, the described embodiments are merely some but not all of the embodiments of the present invention. All other embodiments obtained by a person of ordinary skill in the art based on the embodiments of the present invention without creative efforts shall fall within the protection scope of the embodiments of the present invention.

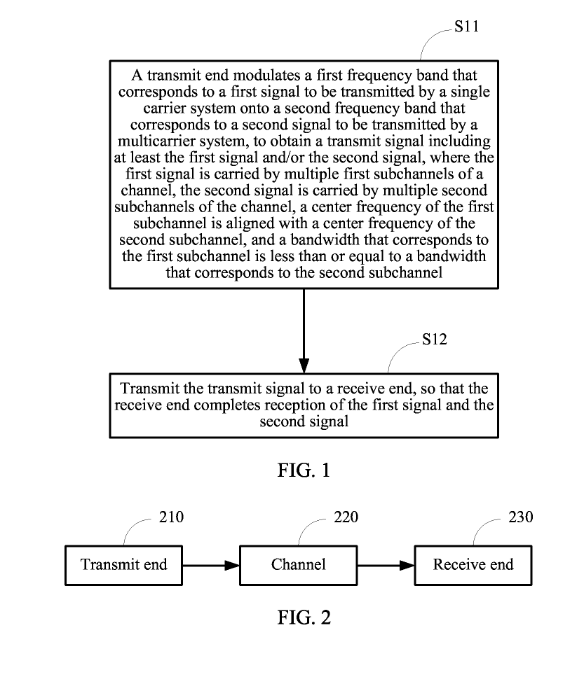

The embodiments provide a signal transmitting method for coexistence of a single carrier system and a multicarrier system. Reference may be made to FIG. 1, a flowchart of a signal transmitting method for coexistence of a single carrier system and a multicarrier system according to a first embodiment. This embodiment is based on a signal transmission architecture shown in FIG. 2. As shown in FIG. 1, the signal transmitting method of this embodiment includes the following steps.

Step S11: A transmit end 210 modulates a first frequency band that corresponds to a first signal to be transmitted by a single carrier system onto a second frequency band that corresponds to a second signal to be transmitted by a multicarrier system, to obtain a transmit signal including at least the first signal and/or the second signal, where the first signal is carried by multiple first subchannels of a channel 220, the second signal is carried by multiple second subchannels of the channel 220, a center frequency of the first subchannel is aligned with a center frequency of the second subchannel, and a bandwidth that corresponds to the first subchannel is less than or equal to a bandwidth that corresponds to the second subchannel.

In the embodiment of the present invention, that a center frequency of the first subchannel is aligned with a center frequency of the second subchannel is specifically embodied as that a spacing between the center frequency of the first subchannel and the center frequency of the second subchannel is an integer multiple of a spacing between two adjacent second subchannels. In this embodiment, preferably, a spacing between center frequencies of the closest first subchannel and second subchannel that correspond to a joint of the first frequency band and the second frequency band is an integer multiple of a spacing between any two adjacent second subchannels.

Step S12: Transmit the transmit signal to a receive end 230, so that the receive end 230 completes reception of the first signal and the second signal.

This embodiment may be construed as combining the first signal to be transmitted by the single carrier system and the second signal to be transmitted by the multicarrier system into one signal, thereby implementing coexistence of the single carrier system and the multicarrier system. In addition, a center frequency of the first signal to be transmitted by the single carrier system is set to be aligned with a center frequency of the second signal to be transmitted by the multicarrier system, so that a frequency of the first signal and a frequency of the second signal are extremely close. Interference of the first signal on the second signal is relatively low, and correspondingly, spectrum spreading can be reduced. Further, a bandwidth of the first frequency band that corresponds to the first signal is less than or equal to a bandwidth of the second frequency band that corresponds to the second signal, and a total bandwidth that corresponds to the second signal on the channel is far greater than a total bandwidth that corresponds to the first signal on the channel, so that the first signal is merely relatively low noise compared with the second signal, and has extremely low interference.

The embodiment further provides a signal transmitting method of a second embodiment. The second embodiment is described in detail based on the signal transmitting method disclosed in the first embodiment. For convenience of description, that a transmit end 210 is a base station and a receive end 220 is a mobile phone is used as an example.

In step S11 of this embodiment, the transmit end 210 first acquires communication content to be sent by a user, and converts the communication content into communication data including multiple data bits. Subsequently, the transmit end 210 performs channel coding on the communication data by using a built-in hardware device or software program, to ensure that a maximum information rate can be achieved on a channel 220 during transmission of the communication data, and that transmission performance is stable at the maximum information rate.

Then, the transmit end 210 performs constellation diagram mapping on the communication data on which the channel coding has been performed, and performs digital modulation on the communication data. Specifically, the multiple data bits included in the communication data are grouped in the following manner: two or more data bits form one bit group; then, each group is mapped to one constellation point in a constellation diagram by means of QPSK (Quadrature Phase Shift Keying), QAM (Quadrature Amplitude Modulation), or another modulation mode. In this case, one constellation point corresponds to one modulation symbol. Therefore, in subsequent transmission, information included in each transmitted modulation symbol is multiple data bits, thereby greatly improving a transmission rate of the communication data.

Then, the transmit end 210 performs multi-rate filtering on the communication data on which the digital modulation has been performed, to improve a radio-frequency signal sampling rate during emission. This step may be implemented by using various types of multi-rate filters in the prior art.

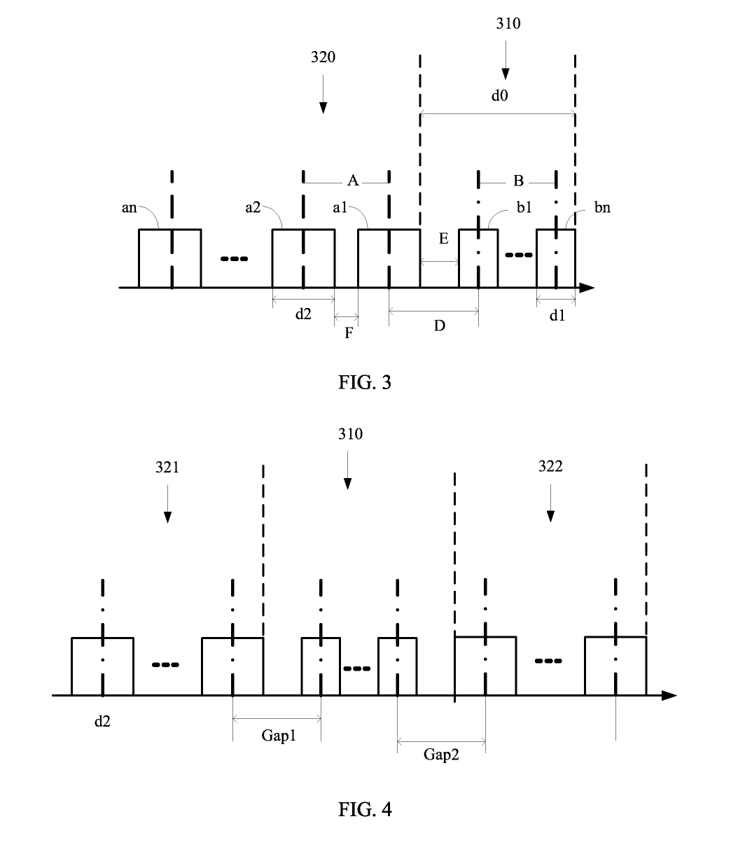

Further, up-conversion is performed on the communication data, to improve a signal frequency during emission and transmission, and satisfy a high frequency needed during radio-frequency emission and transmission over the channel 220. It should be noted that step S11, that is, modulating a first frequency band that corresponds to a first signal to be transmitted by a single carrier system onto a second frequency band that corresponds to a second signal to be transmitted by a multicarrier system, is performed during the up-conversion, to obtain a coexistence frequency band shown in FIG. 3. Finally, digital-to-analog conversion is performed on a digital signal that corresponds to the coexistence frequency band, to obtain an analog transmit signal.

Referring to FIG. 3, the coexistence frequency band includes the first frequency band 310 that corresponds to the first signal to be transmitted by the single carrier system, and the second frequency band 320 that corresponds to the second signal to be transmitted by the multicarrier system. The first frequency band 310 is set on one side of the second frequency band 320. A guard interval D is set between the first frequency band 310 and the second frequency band 320, and a value of D is greater than zero. In addition, the first signal is carried by multiple first subchannels of the channel 220, that is, b1 . . . bn, where the multiple first subchannels have equal or unequal signal bandwidths. The second signal is carried by multiple second subchannels of the channel 220, that is, a1 . . . an, where the multiple second subchannels have equal or unequal signal bandwidths. The first subchannel b1 and the second subchannel a1 are located at a joint of the first frequency band 310 and the second frequency band 320, and a spacing between the first subchannel b1 and the second subchannel a1 is E. A spacing between any two subchannels, for example, a1 and a2, of the second frequency band 320 is F. Center frequencies A of the first subchannels b1 . . . bn are aligned with center frequencies B of the second subchannels a1 . . . an. The spacing E=x*F, where x is a positive integer. A signal bandwidth d1 that corresponds to any first subchannel bn is less than or equal to a signal bandwidth d2 that corresponds to any second subchannel a2, that is, a maximum value of signal bandwidths of the multiple first subchannels b1 . . . bn is less than or equal to a minimum value of signal bandwidths of the multiple second subchannels a1 . . . an.

A representative of the single carrier system is a GSM (Global System for Mobile Communications) system, and a representative of the multicarrier system is an OFDM (orthogonal frequency division multiplexing) system. Therefore, for convenience of description, this embodiment uses the GSM system and the OFDM system as examples to define related parameters. It should be understood that the single carrier system and the multicarrier system of the embodiment of the present invention are not limited thereto. This embodiment is specifically as follows.

1) On the coexistence frequency band, a total signal bandwidth d0 allocated to the GSM system is BW-Whole-New whose value is 1.08 MHZ (6 RB).

2) On the coexistence frequency band, a signal bandwidth corresponding to a second subchannel 222 of the OFDM system is BW-Sub-Old whose value is 15 Hz.

3) On the coexistence frequency band, a signal bandwidth corresponding to a first subchannel 221 of the GSM system is BW-Sub-New whose value is 5 Hz.

4) The guard interval D is Gap whose value is 60 Hz.

5) Center frequencies of multiple first subchannels 221 of the GSM system are F_{sub-carrier}^{sc}(m), where F_{sub-carrier}^{sc}(m) represents a set of center frequencies of m first subchannels 221, mε{1, 2, . . . , K}, K is a quantity of corresponding single carriers on the coexistence frequency band, and a value of K is 64.

6) Center frequencies of multiple second subchannels 222 of the OFDM system is F_{sub-carrier}^{OFDM}(n), and F_{sub-carrier}^{OFDM}(n)=F_{center}^{OFDM}+n*BW_Sub_Old+F_{shift}^{OFDM}, where F_{sub-carrier}^{OFDM}(n) represents a set of center frequencies of n second subchannels 222, nε{1, 2, . . . , M}, M is a quantity of subcarriers that the OFDM system includes on the coexistence band, and a value of M is 2048; F_{center}^{OFDM} represents a center frequency of a frequency band that corresponds to the OFDM system, and F_{shift}^{OFDM} represents a spacing between the center frequency F_{center}^{OFDM} and a center frequency of a second subchannel 222 that corresponds to a subcarrier closest to the center frequency center F_{center}^{OFDM}.

The foregoing example may be construed as dividing a frequency band of 1.08 M from a frequency band of 20 M of the OFDM system, for use by the GSM system. The center frequencies of the first subchannels 221 of the GSM system are aligned with the center frequencies of the second subchannels 222 of the OFDM system, that is, a set of the center frequencies of the first subchannels 221 of the GSM system is a subset of the center frequencies of the second subchannels 222 of the OFDM system, where a specific parameter is expressed as F_{sub-carrier}^{sc}(m)εF_{sub-carrier}^{OFDM}(n). Therefore, when the receive end 230 receives the first signal transmitted by the GSM system and the second signal transmitted by the OFDM system, frequencies that correspond to the first signal and the second signal are extremely close, and the first signal and the second signal may share a corresponding device that is needed. In addition, setting of the guard interval reduces mutual interference during reception of the first signal and the second signal, that is, interference caused by spectrum spreading can be reduced. In addition, the signal bandwidth that corresponds to the first subchannel 221 is less than or equal to the signal bandwidth that corresponds to the second subchannel, where a specific parameter is expressed as BW-Sub-New≦BW-Sub-Old, so that the first single transmitted by the single carrier system is merely relatively low noise compared with the second signal transmitted by the multicarrier system, and has extremely low interference.

Based on the above, this embodiment can reduce the mutual interference between the single carrier system and the multicarrier system during signal transmission, ensure that spectrum resources are shared between heterogeneous systems, and improve spectrum utilization.

The embodiment further provides a signal transmitting method of a third embodiment. The third embodiment is described in detail based on the signal transmitting method disclosed in the second embodiment. This embodiment differs from the second embodiment in using that a transmit end 210 is a mobile phone, and a receive end 220 is a base station as an example.

In step S11 of this embodiment, the transmit end 210 of a single carrier system individually performs channel coding, constellation diagram mapping, multi-rate filtering, and digital-to-analog conversion sequentially on communication data to be transmitted. The transmit end 210 of a multicarrier system individually performs channel coding, constellation diagram mapping, and digital-to-analog conversion sequentially on communication data to be transmitted, and does not perform multi-rate filtering.

Subsequently, up-conversion is performed on a first signal to be transmitted by the single carrier system and a second signal to be transmitted by a multicarrier system, where digital-to-analog conversion has been performed on the first signal and the second signal, to modulate a first frequency band that corresponds to the first signal onto a second frequency band that corresponds to the second signal, and a coexistence frequency band can be obtained. Therefore, an analog signal that corresponds to the coexistence frequency band is the transmit signal of the embodiment.

The embodiment further provides a signal transmitting method of a fourth embodiment. The fourth embodiment is described in detail based on the signal transmitting method disclosed in the second embodiment. This embodiment differs from the second embodiment according to the following.

When up-conversion is performed in step S11, the first frequency band 310 that corresponds to the first signal to be transmitted by the single carrier system is set between the second frequency band 320 that corresponds to the second signal to be transmitted by the multicarrier system. That is, as shown in FIG. 4, the second frequency band 320 includes a first regional frequency band 321 and a second regional frequency band 322, and the first frequency band 310 is set between the first regional frequency band 321 and the second regional frequency band 322. In this case, a guard interval is Gap, including a first guard interval Gap1 between the first frequency band 310 and the second regional frequency band 321, and a second guard interval Gap2 between the first frequency band 310 and the second regional frequency band 322. To avoid mutual interference during reception at the receive end 230, this embodiment sets that Gap1>0 and Gap2>0, and preferably, the Gap1 and Gap2 are set to equal values, and are both 60 Hz.

It should be understood that the parameters and values of the parameters in the foregoing embodiments are merely used to illustrate the examples. In other embodiments, a person skilled in the art may use other definitions according to actual requirements. In addition, the transmit end 210 or the receive end 230 mentioned in the full text of the embodiment of the present invention uses a mobile phone as an example, and is certainly not limited to a mobile phone. The transmit end 210 or the receive end 230 may be any terminal having an M2M (Machine to Machine) communication function, including a tablet computer and the like, and correspondingly, the receive end 230 or the transmit end 210 is not limited to a base station either.

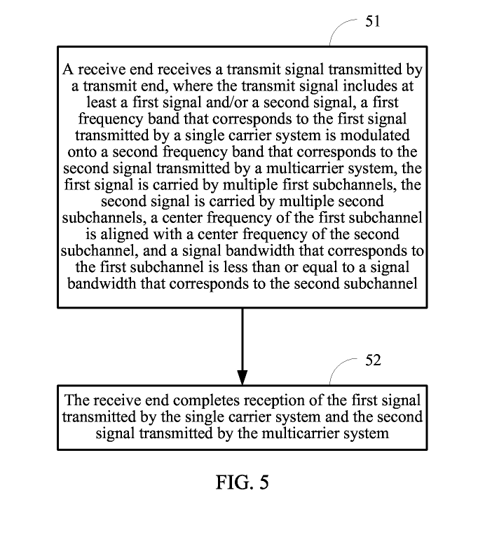

The embodiment further provides a signal receiving method for coexistence of a single carrier system and a multicarrier system. This embodiment is based on the signal transmission architecture shown in FIG. 2. As shown in FIG. 5, the signal receiving method disclosed in this embodiment includes the following.

Step S51: A receive end receives a transmit signal transmitted by a transmit end, where the transmit signal includes at least a first signal and/or a second signal, a first frequency band that corresponds to the first signal transmitted by a single carrier system is modulated onto a second frequency band that corresponds to the second signal transmitted by a multicarrier system, the first signal is carried by multiple first subchannels, the second signal is carried by multiple second subchannels, a center frequency of the first subchannel is aligned with a center frequency of the second subchannel, and a signal bandwidth that corresponds to the first subchannel is less than or equal to a signal bandwidth that corresponds to the second subchannel.

In this embodiment, specifically, a center frequency of the first subchannel being aligned with a center frequency of the second subchannel is the same as that in step S11 of the first embodiment, that is, a spacing between center frequencies of the closest first subchannel and second subchannel that correspond to a joint of the first frequency band and the second frequency band is an integer multiple of a spacing between any two adjacent second subchannels.

Step S52: The receive end completes reception of the first signal transmitted by the single carrier system and the second signal transmitted by the multicarrier system.

In this embodiment, after receiving the transmit signal transmitted by the transmit end 210, the receive end 230 performs analog-to-digital conversion on the analog transmit signal, to obtain a corresponding digital signal. Then, down-conversion is performed on the digital signal, to reduce a signal frequency of the digital signal. At the same time, the first signal transmitted by the single carrier system and the second signal transmitted by the multicarrier system are demodulated, so that the first signal becomes a baseband signal, and the second signal becomes a frequency band signal. Then, multi-rate filtering is performed on the first signal only, to reduce a radio-frequency signal sampling rate during reception of the first signal, and finally, communication data that corresponds to the first signal transmitted by the single carrier system is obtained by means of constellation diagram parsing and channel decoding. At the same time, constellation diagram parsing and channel decoding are performed on the second signal only, to obtain communication data that corresponds to the second signal transmitted by the multicarrier system. In this embodiment, the reception of the first signal and the second signal by the receive end 230 may be construed as a reverse procedure of the foregoing signal transmitting method for coexistence of a single carrier system and a multicarrier system.

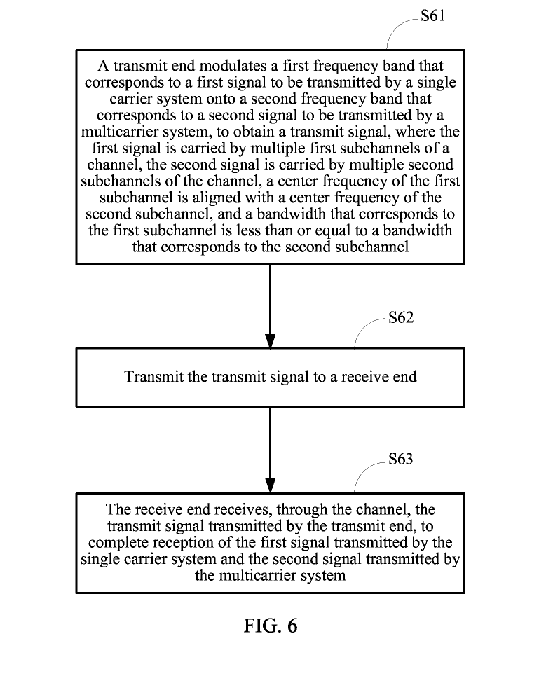

The embodiment further provides a signal transmission method for coexistence of a single carrier system and a multicarrier system. Reference may be made to FIG. 6, a flowchart of a signal transmission method according to a preferable embodiment. This embodiment is based on the signal transmission architecture shown in FIG. 2. As shown in FIG. 6, the signal transmission method of this embodiment includes the following steps.

Step S61: A transmit end 210 modulates a first frequency band that corresponds to a first signal to be transmitted by a single carrier system onto a second frequency band that corresponds to a second signal to be transmitted by a multicarrier system, to obtain a transmit signal, where the first signal is carried by multiple first subchannels 221 of a channel 220, the second signal is carried by multiple second subchannels 222 of the channel 220, a center frequency of the first subchannel 221 is aligned with a center frequency of the second subchannel 222, and a bandwidth that corresponds to the first subchannel 221 is less than or equal to a bandwidth that corresponds to the second subchannel 222.

Step S62: Transmit the transmit signal to a receive end 230.

Step S63: The receive end 230 receives, through the channel 220, the transmit signal transmitted by the transmit end 210, to complete reception of the first signal transmitted by the single carrier system and the second signal transmitted by the multicarrier system.

This embodiment may be construed as a combination of the signal transmitting method shown in FIG. 1 and the signal receiving method shown in FIG. 5. For a specific procedure and beneficial effects, refer to the foregoing, and details are not described herein again. It should be noted that, because signal transmitting and signal receiving are reverse procedures, during an actual application, terminal devices that perform the steps, for example, a multi-rate filter for multi-rate filtering, a converter for up-conversion and down-conversion, a digital-to-analog converter for digital-to-analog conversion and analog-to-digital conversion, may be shared to reduce costs.

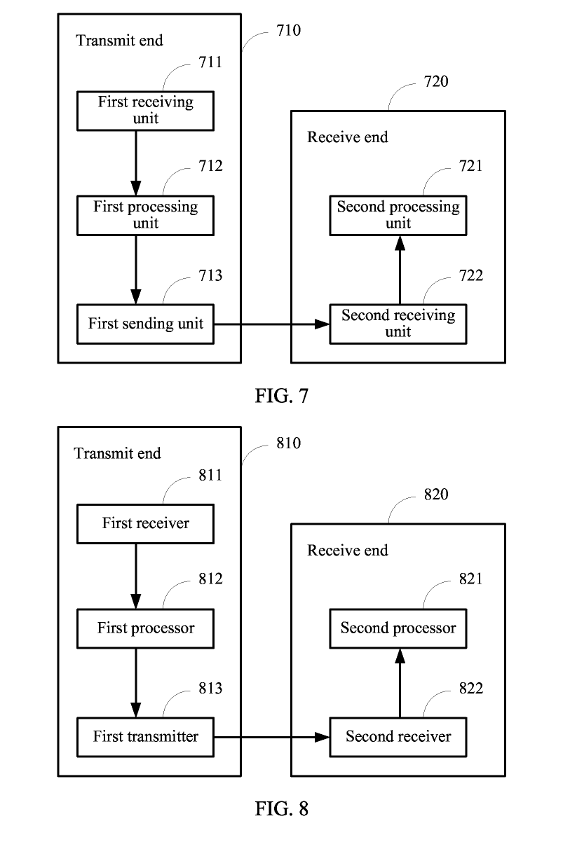

The embodiment further provides a transmit end 710 and a receive end 720 based on the signal transmitting method and the signal receiving method of the foregoing embodiments. As shown in FIG. 7, the transmit end 710 of this embodiment includes a first receiving unit 711, a first processing unit 712, and a first sending unit 713, and the receive end 720 includes a second receiving unit 721 and a second processing unit 722.

The first receiving unit 711 is configured to receive communication content to be sent by a user.

The first processing unit 712 is configured to acquire, according to the communication content, a first signal to be transmitted by a single carrier system and a second signal to be transmitted by a multicarrier system, and modulate a first frequency band that corresponds to the first signal to be transmitted by the single carrier system onto a second frequency band that corresponds to the second signal to be transmitted by the multicarrier system, to obtain a transmit signal including at least the first signal and/or the second signal, where the first signal is carried by multiple first subchannels, the second signal is carried by multiple second subchannels, a center frequency of the first subchannel is aligned with a center frequency of the second subchannel, and a signal bandwidth that corresponds to the first subchannel is less than or equal to a signal bandwidth that corresponds to the second subchannel.

The first sending unit 713 is configured to transmit the transmit signal to the receive end 720.

The second receiving unit 721 is configured to receive the transmit signal transmitted by the transmit end 710.

The second processing unit 722 is configured to complete reception of the first signal transmitted by the single carrier system and the second signal transmitted by the multicarrier system.

According to the foregoing description, this embodiment can reduce mutual interference between the single carrier system and the multicarrier system when signal transmission is performed between the transmit end 710 and the receive end 720, ensure that spectrum resources are shared between heterogeneous systems, and improve spectrum utilization.

It should be noted that, as components of the transmit end 710 and the receive end 720, the foregoing modules may be or may not be physical blocks. The foregoing modules may be located in one place or may be distributed over multiple network units. The foregoing modules may be implemented in a form of hardware or may be implemented in a form of software functional blocks. Some or all of the modules may be selected according to actual requirements, to achieve objectives of the solution of this embodiment.

The embodiment further provides a transmit end 810 and a receive end 820 based on the signal transmitting method and the signal receiving method of the foregoing embodiments. As shown in FIG. 8, the transmit end 810 of this embodiment includes a first receiver 811, a first processor 812, and a first transmitter 813, and the receive end 820 includes a second receiver 821 and a second processor 822.

The first receiver 811 is configured to receive communication content to be sent by a user.

The first processor 810 is configured to acquire, according to the communication content, a first signal to be transmitted by a single carrier system and a second signal to be transmitted by a multicarrier system, and modulate a first frequency band that corresponds to the first signal to be transmitted by the single carrier system onto a second frequency band that corresponds to the second signal to be transmitted by the multicarrier system, to obtain a transmit signal including at least the first signal and/or the second signal, where the first signal is carried by multiple first subchannels, the second signal is carried by multiple second subchannels, a center frequency of the first subchannel is aligned with a center frequency of the second subchannel, and a signal bandwidth that corresponds to the first subchannel is less than or equal to a signal bandwidth that corresponds to the second subchannel.

The first transmitter 813 is configured to transmit the transmit signal to the receive end 820.

The second receiver 821 is configured to receive the transmit signal transmitted by the transmit end 810.

The second processor 822 is configured to complete reception of the first signal transmitted by the single carrier system and the second signal transmitted by the multicarrier system.

In summary, the embodiment designs that a transmit end modulates a first frequency band that corresponds to a first signal to be transmitted by a single carrier system onto a second frequency band that corresponds to a second signal to be transmitted by a multicarrier system, to obtain a transmit signal including at least the first signal and/or the second signal, and transmits the transmit signal to a receive end through a channel, so that the receive end completes reception of the first signal and the second signal. Center frequencies of multiple first subchannel are aligned with center frequencies of multiple second subchannel, and a signal bandwidth that corresponds to the first subchannel is less than or equal to a signal bandwidth that corresponds to the second subchannel, thereby reducing mutual interference between the single carrier system and the multicarrier system during signal transmission, ensuring that spectrum resources are shared between heterogeneous systems, and improving spectrum utilization.

The foregoing descriptions are merely embodiments, and the protection scope of the embodiment of the present invention is not limited thereto. All equivalent structure or process changes made according to the content of this specification and accompanying drawings in the embodiment of the present invention or by directly or indirectly applying the present invention in other related technical fields shall fall within the protection scope of the embodiment of the present invention.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A signal transmitting method, comprising:
modulating, by a transmit end, a first frequency band that corresponds to a first signal to be transmitted by a single carrier system onto a second frequency band that corresponds to a second signal to be transmitted by a multicarrier system, to obtain a transmit signal, wherein the transmit signal comprises one or more of the first signal and the second signal, the first signal is carried by a plurality of first subchannels, the second signal is carried by a plurality of second subchannels, a spacing between a center frequency of each of the plurality of first subchannels and a center frequency of each of the second subchannels is an integer multiple of a spacing between two adjacent second subchannels, and a signal bandwidth that corresponds to the plurality of first subchannels is less than or equal to a signal bandwidth that corresponds to the plurality of second subchannels; and
transmitting the transmit signal to a receive end.

2. The method according to claim 1, wherein the method further comprises:
setting a guard interval between the first frequency band and the second frequency band.

3. The method according to claim 1, wherein the transmit end is a base station and the receive end is a mobile phone, and the modulating the first frequency band that corresponds to the first signal to be transmitted by the single carrier system onto the second frequency band that corresponds to the second signal to be transmitted by the multicarrier system comprises:
sequentially performing, by the transmit end, channel coding, constellation diagram mapping, multi-rate filtering, and up-conversion on communication data to be sent, to acquire the first frequency band that corresponds to the first signal to be transmitted by the single carrier system, and modulating the first frequency band onto the second frequency band that corresponds to the second signal to be transmitted by the multicarrier system, to obtain a coexistence frequency band; and
performing digital-to-analog conversion on a digital signal that corresponds to the coexistence frequency band, to obtain the transmit signal.

4. The method according to claim 1, wherein the transmit end is a mobile phone and the receive end is a base station, and the modulating, by the transmit end, the first frequency band that corresponds to the first signal to be transmitted by the single carrier system onto the second frequency band that corresponds to the second signal to be transmitted by the multicarrier system comprises:
separately performing, by the transmit end, channel coding, constellation diagram mapping, and digital-to-analog conversion sequentially on communication data to be sent by the single carrier system and communication data to be sent by the multicarrier system; and
performing up-conversion on the first signal to be transmitted by the single carrier system and the second signal to be transmitted by the multicarrier system, wherein digital-to-analog conversion has been performed on the first signal and the second signal, to acquire the first frequency band that corresponds to the first signal, and modulating the first frequency band onto the second frequency band that corresponds to the second signal, to obtain a coexistence frequency band and the transmit signal that corresponds to the coexistence frequency band.

5. The method according to claim 1, wherein the single carrier system is a Global System for Mobile Communications (GSM) system, and the multicarrier system is an Orthogonal Frequency Division Multiplexing (OFDM) system.

6. A transmit end, comprising:
a processor, configured to modulate a first frequency band that corresponds to a first signal to be transmitted by a single carrier system onto a second frequency band that corresponds to a second signal to be transmitted by a multicarrier system, to obtain a transmit signal, wherein the transmit signal comprises one or more of the first signal and the second signal, the first signal is carried by a plurality of first subchannels, the second signal is carried by a plurality of second subchannels, a spacing between a center frequency of each of the plurality of first subchannels and a center frequency of each of the plurality of second subchannels is an integer multiple of a spacing between two adjacent second subchannels, and a signal bandwidth that corresponds to the plurality of first subchannels is less than or equal to a signal bandwidth that corresponds to the plurality of second subchannels; and
a transceiver, configured to receive the transmit signal obtained by the processor, and transmit the transmit signal to a receive end.

7. The transmit end according to claim 6, wherein the processor is further configured to set a guard interval between the first frequency band and the second frequency band.

8. The transmit end according to claim 6, wherein the transmit end is a base station and the receive end is a mobile phone, and the processor is further configured to:
sequentially perform channel coding, constellation diagram mapping, multi-rate filtering, and up-conversion on communication data to be sent, to acquire the first frequency band that corresponds to the first signal to be transmitted by the single carrier system;
modulate the first frequency band onto the second frequency band that corresponds to the second signal, to obtain a coexistence frequency band; and
perform digital-to-analog conversion on a signal that corresponds to the coexistence frequency band, to obtain the transmit signal.

9. The transmit end according to claim 6, wherein the transmit end is a mobile phone and the receive end is a base station, and the processor is further configured to:
separately perform channel coding, constellation diagram mapping, and digital-to-analog conversion sequentially on communication data to be sent by the single carrier system and communication data to be sent by the multicarrier system;
perform up-conversion on the first signal and the second signal on which digital-to-analog conversion has been performed, to acquire the first frequency band that corresponds to the first signal to be transmitted by the single carrier system; and
modulate the first frequency band onto the second frequency band that corresponds to the second signal to be transmitted by the multicarrier system, to obtain a coexistence frequency band and the transmit signal that corresponds to the coexistence frequency band.

10. The transmit end according to claim 6, wherein the single carrier system is a Global System for Mobile Communications (GSM) system, and the multicarrier system is a Orthogonal Frequency Division Multiplexing (OFDM) system.

11. A signal receiving method, comprising:
receiving, by a receive end, a transmit signal transmitted by a transmit end, wherein the transmit signal comprises one or more of a first signal and a second signal, a first frequency band that corresponds to the first signal transmitted by a single carrier system is modulated onto a second frequency band that corresponds to the second signal transmitted by a multicarrier system, the first signal is carried by a plurality of first subchannels, the second signal is carried by a plurality of second subchannels, a spacing between a center frequency of each of the plurality of first subchannels and a center frequency of each of the plurality of second subchannels is an integer multiple of a spacing between two adjacent second subchannels, and a signal bandwidth that corresponds to the plurality of first subchannels is less than or equal to a signal bandwidth that corresponds to the plurality of second subchannels; and
completing, by the receive end, reception of the first signal transmitted by the single carrier system and the second signal transmitted by the multicarrier system.

12. The method according to claim 11, wherein after receiving the transmit signal, the method comprises:
performing analog-to-digital conversion on the transmit signal, to obtain a corresponding digital signal;
performing down-conversion on the digital signal, to demodulate the first frequency band that corresponds to the first signal and the second frequency band that corresponds to the second signal, and to acquire the first signal transmitted by the single carrier system and the second signal transmitted by the multicarrier system; and
separately performing constellation diagram parsing and channel decoding sequentially on the first signal and the second signal, to obtain corresponding communication data.

13. The method according to claim 11, wherein the single carrier system is a Global System for Mobile Communications (GSM) system, the multicarrier system is an Orthogonal Frequency Division Multiplexing (OFDM) system, the transmit end is a mobile phone and the receive end is a base station.

14. The method according to claim 11, wherein the single carrier system is a Global System for Mobile Communications (GSM) system, the multicarrier system is an Orthogonal Frequency Division Multiplexing (OFDM) system, the transmit end is a base station and the receive end is a mobile phone.

15. A receive end, comprising:
a receiver, configured to receive a transmit signal transmitted by a transmit end, wherein the transmit signal comprises one or more of a first signal and a second signal, a first frequency band that corresponds to the first signal transmitted by a single carrier system is modulated onto a second frequency band that corresponds to the second signal transmitted by a multicarrier system, the first signal is a plurality of first subchannels, the second signal is carried by a plurality of second subchannels, a spacing between a center frequency of each of the plurality of first subchannels and a center frequency of each of the plurality of second subchannels is an integer multiple of a spacing between two adjacent second subchannels, and a signal bandwidth that corresponds to the plurality of first subchannels is less than or equal to a signal bandwidth that corresponds to the plurality of second subchannels; and
a processor, configured to complete, according to the transmit signal received by the receiver, reception of the first signal transmitted by the single carrier system and the second signal transmitted by the multicarrier system.

16. The receive end according to claim 15, wherein the processor is further configured to:
perform analog-to-digital conversion on the transmit signal, to obtain a corresponding digital signal, and perform down-conversion on the digital signal, to demodulate the first frequency band that corresponds to the first signal and the second frequency band that corresponds to the second signal, to acquire the first signal transmitted by the single carrier system and the second signal transmitted by the multicarrier system; and
separately perform constellation diagram parsing and channel decoding sequentially on the first signal and the second signal, to obtain corresponding communication data.

17. The receive end according to claim 15, wherein the single carrier system is a Global System for Mobile Communications (GSM) system, the multicarrier system is an Orthogonal Frequency Division Multiplexing (OFDM) system, the transmit end is a mobile phone and the receive end is a base station.

18. The receive end according to claim 15, wherein the single carrier system is a Global System for Mobile Communications (GSM) system, the multicarrier system is an Orthogonal Frequency Division Multiplexing (OFDM) system, the transmit end is a base station, and the receive end is a mobile phone.

19. An apparatus, comprising a processor coupled with a non-transitory storage medium storing executable instructions; wherein the executable instructions, when executed by the processor, cause the processor to:
modulate a first frequency band that corresponds to a first signal to be transmitted by a single carrier system onto a second frequency band that corresponds to a second signal to be transmitted by a multicarrier system, to obtain a transmit signal, wherein the transmit signal comprises one or more of the first signal and the second signal, the first signal is carried by a plurality of first subchannels, the second signal is carried by a plurality of second subchannels, a spacing between a center frequency of each of the plurality of first subchannels and a center frequency of each of the plurality of second subchannels is an integer multiple of a spacing between two adjacent second subchannels, and a signal bandwidth that corresponds to the plurality of first subchannels is less than or equal to a signal bandwidth that corresponds to the plurality of second subchannels; and
transmit the transmit signal to a receive end.
